(19) United States
(12) Patent Application Publication
(10) Pub. No.: US 2026/0135264 A1
(43) Pub. Date: May 14, 2026

(54) ENERGY STORAGE DEVICE

(71) Applicant: TOYOTA JIDOSHA KABUSHIKI KAISHA, Toyota-shi (JP)

(72) Inventors: Kunihiro Tsunekawa, Toyota-shi (JP); Koki Nakada, Toyota-shi (JP); Shinya Takeshita, Toyota-shi (JP); Naoyuki Takahashi, Toyoake-shi (JP); Ryo Kimura, Nagoya-shi (JP); Kazuhito Kato, Toyota-shi (JP); Toshihiro Shimonaka, Toyota-shi (JP); Kota Ichisawa, Toyota-shi (JP); Kenta Miyahara, Toyohashi-shi (JP)

(73) Assignee: TOYOTA JIDOSHA KABUSHIKI KAISHA, Toyota-shi (JP)

(21) Appl. No.: 19/364,211

(22) Filed: Oct. 21, 2025

(30) Foreign Application Priority Data
Nov. 13, 2024 (JP) 2024-198065

(51) Int. Cl. H01M 50/517; H01M 10/613; H01M 50/367; H01M 50/503; H01M 50/507; H01M 50/519

(52) U.S. Cl. CPC H01M 50/517; H01M 10/613; H01M 50/367; H01M 50/503; H01M 50/507; H01M 50/519

(57) ABSTRACT

An energy storage device includes a first energy storage cell (energy storage cell), a second energy storage cell (energy storage cell), a first conductor member (conductor member), and a second conductor member (conductor member). The first energy storage cell and the second energy storage cell are electrically connected to each other via the first conductor member and the second conductor member. The energy storage device further includes one or more resin members (protrusions of a resin sheet) that join the first conductor member and the second conductor member.

### CROSS-REFERENCE TO RELATED APPLICATION

This application claims priority to Japanese Patent Application No. 2024-198065 filed on Nov. 13, 2024. The disclosure of the above-identified application, including the specification, drawings, and claims, is incorporated by reference herein in its entirety.

### BACKGROUND

### 1. Technical Field

The present disclosure relates to energy storage devices.

### 2. Description of Related Art

Chinese Unexamined Patent Application Publication No. 116686151 discloses an energy storage device including a plurality of energy storage cells fixed in a case (housing cavity). Electrode terminals of each energy storage cell are provided so as to face the bottom wall of the case.

### SUMMARY

In the energy storage device described in the above-mentioned Chinese Unexamined Patent Application Publication No. 116686151, maintaining the connections between energy storage cells and conductor members (e.g., busbars) is not necessarily easy. For example, when the conductor members vibrate, connection failures (e.g., loosening of fastened joints) tend to occur at the connections between the energy storage cells and the conductor members.

The present disclosure has been made to address the above issue, and an object thereof is to make it easier to maintain the connections between energy storage cells and conductor members.

An aspect of the present disclosure provides an energy storage device. The energy storage device includes a first energy storage cell, a second energy storage cell, a first conductor member, and a second conductor member. The first energy storage cell and the second energy storage cell are electrically connected to each other via the first conductor member and the second conductor member. The energy storage device further includes one or more resin members that join the first conductor member and the second conductor member.

According to the present disclosure, it is possible to easily maintain the connections between energy storage cells and conductor members.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 illustrates an overview of an energy storage device according to an embodiment of the present disclosure;

FIG. 2 shows the interior of the energy storage device according to the embodiment of the present disclosure;

FIG. 3 is an end view of the energy storage device taken along line III-III in FIG. 2;

FIG. 4 illustrates the structure of each conductor member shown in FIG. 2;

FIG. 5 illustrates a conductor member according to a first modification; and

FIG. 6 illustrates a conductor member according to a second modification.

### DETAILED DESCRIPTION OF EMBODIMENTS

An embodiment of the present disclosure will be described in detail with reference to the drawings. The same or corresponding portions are denoted by the same signs throughout the drawings, and description thereof will not be repeated. In the drawings referred to in the following description, the X-axis, the Y-axis, and the Z-axis indicate three axes that are perpendicular to each other. Hereinafter, the directions indicated by the arrows of the X-axis, Y-axis, and Z-axis are denoted with a plus sign “+,” and the opposite directions are denoted with a minus sign “−.”

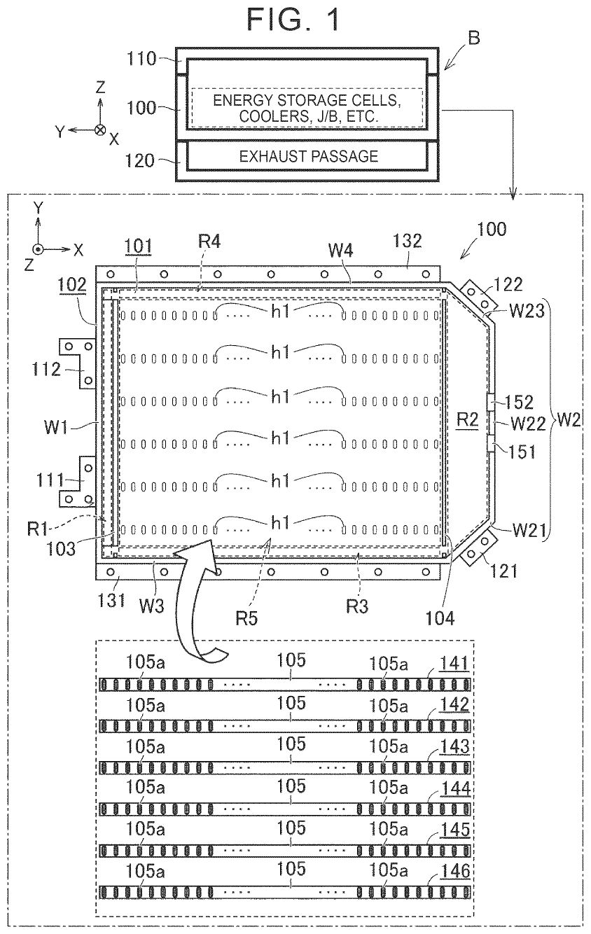

FIG. 1 illustrates an overview of an energy storage device according to the present embodiment.

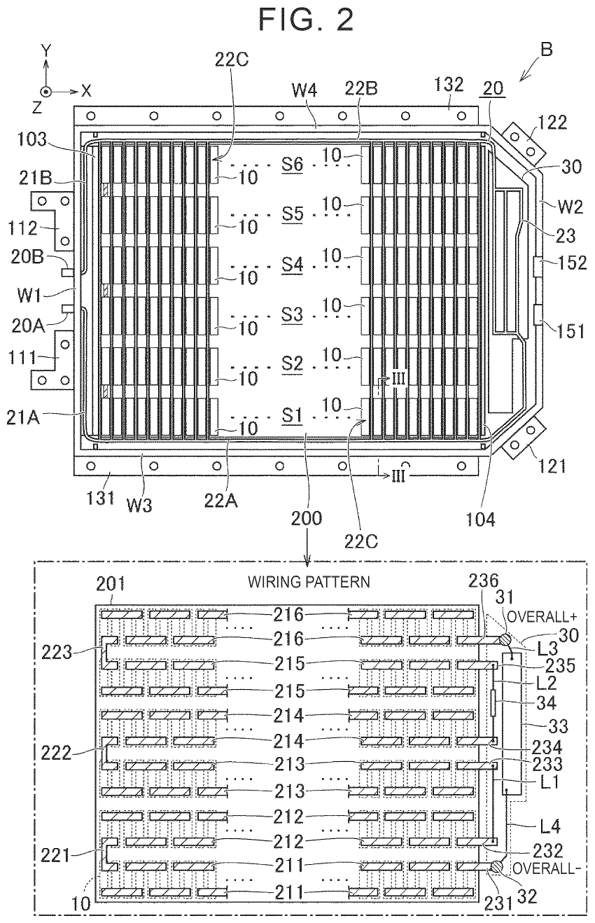

Referring to FIG. 1, an energy storage device B according to the present embodiment includes a lower case 100 (first housing member), an upper cover 110 (second housing member), and a common panel 120 (third housing member), and these components serve as a housing for the energy storage device B. The lower case 100 is open upward (on the +Z-side), and houses a plurality of energy storage cells and various components associated with these energy storage cells. As will be described in detail later, the lower case 100 houses the energy storage cells, a cooler, a junction box (hereinafter referred to as “J/B”), etc. (see FIG. 2). The upper cover 110 and the common panel 120 are each fixed to the lower case 100. The upper cover 110 is disposed above the lower case 100 and serves as a lid for the lower case 100. The common panel 120 is disposed below (on the −Z-side of) the lower case 100, and serves to reduce impacts on the lower case 100 caused by road surface interference. An exhaust passage is formed between the lower case 100 and the common panel 120.

For example, in the state where the energy storage device B is mounted on a vehicle, the −Z-side is downward (downward in the vertical direction), the +Z-side is upward (upward in the vertical direction), the −X-side is toward the front of the vehicle, and the +X-side is toward the rear of the vehicle. The energy storage device B may serve as a traction energy storage device that is commonly referred to as a “battery pack.” The vehicle may be a battery electric vehicle (BEV) or another type of electrified vehicle (xEV).

The lower part of FIG. 1 shows the lower case 100 in an empty state (a state in which nothing is housed) as viewed from above (+Z-side). The lower case 100 includes a bottom wall 101 (bottom) and a peripheral wall 102 (peripheral portion). The bottom wall 101 includes regions R1 to R5. The peripheral wall 102 includes side walls W1 to W4. Side walls W1, W2, W3, W4 correspond to the ends on the −X-side, +X-side, −Y-side, and +Y-side of the lower case 100, respectively. The side wall W2 includes side walls W21 to W23. The side walls W21 to W23 are located on the +X-side of the side walls W3, W4 extending in the X-direction. The side walls W21, W23 are provided with brackets 121, 122, respectively. The side wall W22 is provided with exhaust valves 151, 152. The side wall W22 is connected to the side walls W3, W4 via the side walls W21, W23, respectively. The opposite (−X-side) ends of the side walls W3, W4 are connected to each other via the side wall W1 extending in the Y-direction. The side walls W3, W4 are provided with brackets 131, 132, respectively. The side wall W1 is provided with brackets 111, 112. Each of the side walls W1 to W4 stands from the peripheral edge of the bottom wall 101 toward the +Z-side. The internal space of the lower case 100 is surrounded by the side walls W1 to W4. The energy storage device B may be connected to the body (e.g., a floor panel) of the vehicle by fastening each of the brackets to a floor member of the vehicle.

The bottom wall 101 is provided with partition walls 103, 104 extending in the Y-direction. The partition walls 103, 104 may be fastened to the bottom wall 101. The partition wall 104 is located on the +X-side of the partition wall 103. The partition walls 103, 104 stand from the bottom wall 101 toward the +Z-side. The region R5 is a rectangular region located in the central portion of the lower case 100 and is defined by the partition walls 103, 104. The region R5 is a region where a wiring board 200 and energy storage stacks S1 to S6 (see FIG. 2), which will be described later, are arranged.

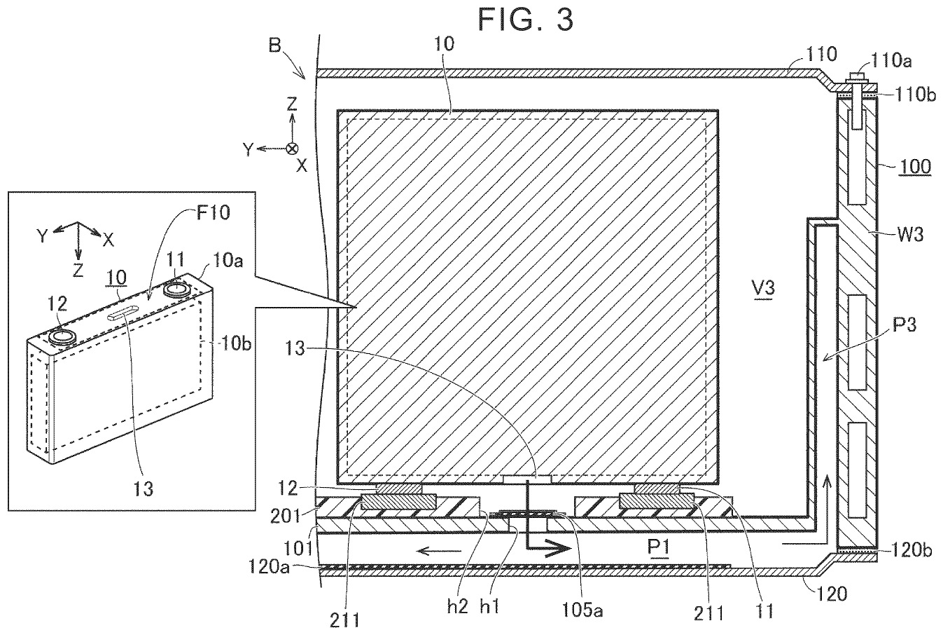

The region R5 has openings h1 at positions where the energy storage cells are disposed. Each of the openings h1 is disposed so as to face a valve 13 (see FIG. 3) of a corresponding one of energy storage cells 10, which will be described later, in the Z-direction. The openings h1 are aligned in the X-direction to form rows of the openings h1. The number of rows (rows of the openings h1) formed in the bottom wall 101 corresponds to the number of energy storage stacks. The openings h1 are holes that extend through the bottom wall 101. The openings h1 are formed by, for example, punching.

In the embodiment, cover members 141 to 146 are provided in the region R5 of the bottom wall 101. All of the openings h1 formed in the bottom wall 101 are thus covered by the cover members 141 to 146. Each of the cover members 141 to 146 includes a base material 105 that is elongated in the X-direction, and N lids 105a arranged in the X-direction. In the present embodiment, the number of energy storage cells included in one energy storage stack is also N. N is, for example, 20 or more and 50 or less. However, the present disclosure is not limited to this, and N may be 2 or more and less than 20, or may be more than 50.

The base material 105 may have an adhesive on its one surface (adhesive surface). The base material 105 may be, for example, an adhesive tape such as a polypropylene (PP) tape. The N lids 105a are formed on the base material 105. In the present embodiment, the lids 105a contain mica. The N lids 105a of each of the cover members 141, 142, 143, 144, 145, 146 are formed so as to close the openings h1 located below a corresponding one of the energy storage stacks S1, S2, S3, S4, S5, S6 (see FIG. 2) described later. The size of the lid 105a is the same as or greater than the size of the opening h1. For example, the N lids 105a may be formed on the base material 105 by attaching N pieces of mica foil to the adhesive surface of the base material 105. Alternatively, the N lids 105a may be formed on the base material 105 by forming N through holes in the base material 105 and providing mica foil in each of the through holes. Each of the cover members 141 to 146 are attached to the upper surface (the +Z-side surface) of the bottom wall 101 via, for example, the adhesive surface of the base materials 105. As described above, the portions of the lower case 100 that faces the valves 13 (FIG. 3) of the energy storage cell 10 contain mica. Mica is excellent in heat resistance and electrical insulation properties.

The regions R3, R4 are provided on the −Y- and +Y-sides of the region R5, respectively. The region R1 is provided outward (on the −X-side) of the partition wall 103. The region R2 is provided outward of (on the +X-side) of the partition wall 104. The region R2 is a region where a battery circuit unit 30 (FIG. 2), which will be described later, is disposed. The region R2 is defined by the partition wall 104 and the side wall W2. In the present embodiment, the bottom wall 101, the peripheral wall 102, and the partition walls 103, 104 are each made of metal. However, the material of these walls can be changed as appropriate.

FIG. 2 shows the interior of the lower case 100 (the interior of the energy storage device B) with the upper cover 110 removed, as viewed from above. Referring to FIG. 2, the energy storage stacks S1 to S6, a cooling device 20, the battery circuit unit 30, and the wiring board 200 are housed between the lower case 100 and the upper cover 110. Each of the energy storage stacks S1 to S6 includes N energy storage cells 10 arranged in the X-direction. The configuration of each energy storage cell will be described in detail later. The wiring board 200 has a wiring pattern for the energy storage stacks S1 to S6. The battery circuit unit 30 includes a circuit electrically connected to the energy storage stacks S1 to S6. The battery circuit unit 30 may be a single unit, or may include a plurality of units.

The cooling device 20 includes ports 20A, 20B, pipes 21A, 21B extending in the Y-direction, pipes 22A, 22B extending in the X-direction, a plurality of coolers 22C extending in the Y-direction, and a cooling pipe 23. These components are connected in the following order from the upstream side: port 20A, pipe 21A, pipe 22A, cooling pipe 23, pipe 22B, pipe 21B, and port 20B. The pipes 22A, 22B are connected to each other via the coolers 22C (cooling plates) arranged in the X-direction. In each energy storage stack, a cooler 22C is disposed between the energy storage cells adjacent to each other in the X-direction. The adjacent energy storage cells are cooled by a cooling medium flowing through a channel formed inside the cooler 22C. Each cooler 22C has a channel communicating with each of the pipes 22A, 22B. The cooling pipe 23 is configured to cool the battery circuit unit 30.

Referring to FIGS. 1 and 2, the ports 20A, 20B are provided on the side wall W1. The port 20B is located on the +Y-side of the port 20A. The pipes 21A, 21B are disposed in the region R1. The pipes 22A, 22B are disposed in the regions R3, R4, respectively. The cooling pipe 23 is disposed in the region R2. The coolers 22C are disposed in the region R5. The cooling medium supplied from the port 20A to the pipe 21A flows through the pipe 21A toward the −Y-side. The cooling medium that has entered the pipe 22A from the pipe 21A flows through the pipe 22A toward the +X-side, namely toward the cooling pipe 23, and also flows into the channels in the coolers 22C. The cooling medium that has entered the coolers 22C from the pipe 22A flows toward the +Y-side, namely toward the pipe 22B, while sequentially cooling the energy storage stacks S1 to S6. The cooling medium that has entered the cooling pipe 23 from the pipe 22A flows toward the +Y-side, namely toward the pipe 22B, while cooling the battery circuit unit 30. The cooling medium that has entered the pipe 22B from the coolers 22C or the cooling pipe 23 flows through the pipe 22B toward the −X-side, namely toward the pipe 21B. The cooling medium then flows through the pipe 21B toward the −Y-side and flows out from the port 20B. The cooling medium may be a liquid (such as water, oil, or antifreeze solution) or a gas.

In the present embodiment, the wiring board 200 is disposed on the +Z-side of the bottom wall 101, and the energy storage stacks S1 to S6 are disposed on the +Z-side of the wiring board 200.

FIG. 3 is an end view of the energy storage device B taken along line III-III in FIG. 2. A perspective view of the energy storage cell 10 is shown on the left side of FIG. 3.

As shown in the perspective view on the left side of FIG. 3, the energy storage cell 10 includes a case 10a and an electrode assembly 10b housed in the case 10a. The case 10a is a rectangular parallelepiped case. The electrode assembly 10b may include one or more windings (e.g., two windings). The winding has a structure in which, for example, a cathode sheet and an anode sheet are wound with a separator interposed therebetween. Each of the cathode sheet and the anode sheet includes an electrode foil and an active material layer. The energy storage cell 10 is a secondary cell such as a lithium-ion cell, a nickel metal hydride cell, or a sodium-ion cell. In the present embodiment, a liquid lithium-ion cell is used as the energy storage cell 10. The case 10a contains an electrolyte solution together with the electrode assembly 10b. The secondary cell may be of any type, and may be, for example, an all-solid-state secondary cell. A stack (e.g., a stack in which a cathode sheet and an anode sheet are stacked with a separator interposed therebetween) may be used instead of the winding.

The energy storage cell 10 has electrode terminals 11, 12 and the valve 13 on the same surface. Specifically, the electrode terminals 11, 12 and the valve 13 are provided on a surface F10 of the case 10a. The surface F10 corresponds to an end face of the energy storage cell 10 on one side in the height direction (Z-direction). The valve 13 serves as an exhaust valve. The case 10a is basically maintained in a sealed state. However, when the pressure inside the case 10a exceeds a first reference value, the valve 13 opens to reduce the pressure inside the case 10a. The electrode terminal 11 and the electrode terminal 12 are respectively electrically connected to the cathode sheet and the anode sheet of the electrode assembly 10b, and respectively serve as a cathode terminal and an anode terminal. The portions of the case 10a that surround the electrode terminals 11, 12 may be made of an insulating material, and the other portions of the case 10a may be made of metal. However, the present disclosure is not limited to this, and the case 10a may be made of any material.

In the present embodiment, the energy storage cells included in the energy storage stacks S1 to S6 have the same configuration (the configuration shown in FIG. 3). Forming the energy storage stacks S1 to S6 using the same type of energy storage cells 10 facilitates the manufacturing of the energy storage device B and reduces the manufacturing cost. However, the present disclosure is not limited to this, and each energy storage stack may include a plurality of types of energy storage cells. The number of energy storage stacks can be changed as appropriate. The number of energy storage stacks may be one or more.

The energy storage cells included in the energy storage stacks S1 to S6 are electrically connected by the wiring pattern of the wiring board 200. The wiring board 200 is, for example, a panel with a wiring pattern. An example of the wiring pattern of the wiring board 200 is shown in the lower part of FIG. 2.

Specifically, the wiring board 200 includes a rectangular substrate 201, a plurality of conductor members 211, a plurality of conductor members 212, a plurality of conductor members 213, a plurality of conductor members 214, a plurality of conductor members 215, a plurality of conductor members 216, conductor members 221 to 223, and conductor members 231 to 236. The substrate 201 is an insulating substrate that has insulating properties. The substrate 201 may contain a resin (e.g., a thermosetting resin).

Each of the conductor members 211 electrically connects the energy storage cells included in the energy storage stack S1. Each of the conductor members 212 electrically connects the energy storage cells included in the energy storage stack S2. Each of the conductor members 213 electrically connects the energy storage cells included in the energy storage stack S3. Each of the conductor members 214 electrically connects the energy storage cells included in the energy storage stack S4. Each of the conductor members 215 electrically connects the energy storage cells included in the energy storage stack S5. Each of the conductor members 216 electrically connects the energy storage cells included in the energy storage stack S6.

The conductor member 221 electrically connects the energy storage stacks S1, S2. The conductor member 222 electrically connects the energy storage stacks S3, S4. The conductor member 223 electrically connects the energy storage stacks S5, S6. The conductor members 231, 232, 233, 234, 235, 236 electrically connect the energy storage stacks S1, S2, S3, S4, S5, S6 to the battery circuit unit 30, respectively.

In the present embodiment, the wiring pattern of the wiring board 200 is formed by the above conductor members. Each of the conductor members 211 to 216, 221 to 223, 231 to 236 are, for example, a plate-shaped member made of metal. Each of the conductor members 221 to 223 may be a U-shaped plate member. Each conductor member may be a busbar. In the present embodiment, each of the conductor members is fixed in a corresponding one of recesses formed in the surface (+Z-side surface) of the substrate 201. The lower part of each conductor member is embedded in the substrate 201. However, the recesses (steps) for the conductor members may not be formed in the surface of the substrate 201. Each conductor member may be bonded to a flat surface of the substrate 201. Each conductor member may be made of any material and may have any shape.

The wiring board 200 is electrically connected to the battery circuit unit 30. As shown in FIG. 2, the battery circuit unit 30 includes an overall positive terminal 31, an overall negative terminal 32, a J/B 33, a fuse 34, and electrical wires L1 to L4. The overall positive terminal 31 is located at the end on the cathode side of all the entire energy storage stacks S1 to S6 (all energy storage cells). The overall negative terminal 32 is located at the end on the anode side of all the energy storage stacks S1 to S6 (all the energy storage cells). The electrical wire L1 electrically connects the conductor member 232 and the conductor member 233. The electrical wire L2 electrically connects the conductor member 234 and the conductor member 235. The fuse 34 is provided on the electrical wire L2. The conductor member 236 is connected to the overall positive terminal 31. The electrical wire L3 electrically connects the overall positive terminal 31 and the J/B 33. The conductor member 231 is connected to the overall negative terminal 32. The electrical wire L4 electrically connects the overall negative terminal 32 and the J/B 33. The J/B 33 houses various electrical devices. The J/B 33 may include at least one of a relay, a fuse, a resistive element, a current sensor, and a connector (e.g., a connector to an in-vehicle charger). The battery circuit unit 30 may further include either or both of a battery management system (BMS) and an electronic control unit (ECU).

The partition wall 104 may have openings for passing the conductor members 231 to 236 therethrough. Alternatively, an electrical wire (e.g., a cable) connected to the wiring board 200 may be passed above the partition wall 104 and connected to the battery circuit unit 30. The partition walls 103, 104 may not be provided. Either or both of the partition walls 103, 104 may be omitted.

Each of the energy storage stacks S1 to S6 includes the same number of energy storage cells, and is arranged such that the positions of the energy storage cells are aligned among the energy storage stacks S1 to S6. Accordingly, each set of six energy storage cells 10 aligned in the Y-direction forms a row (row in the Y-direction). The rows are aligned in the X-direction. A total of “6×N” energy storage cells 10 are arranged in a matrix with six rows in the Y-direction and N columns in the X-direction. In the wiring pattern shown in FIG. 2, a plurality of parallel-connected units is connected in series. In each energy storage stack, the N energy storage cells 10 are arranged such that the positional relationship between the electrode terminal 11 (cathode terminal) and the electrode terminal 12 (anode terminal) is reversed every two energy storage cells 10. Each of the conductor members 211 to 216 connects every two energy storage cells of its corresponding energy storage stack in parallel and connects the resulting parallel-connected units (the energy storage cells connected in parallel) in series. How the energy storage cells are connected can be changed as appropriate. For example, the number of energy storage cells connected in parallel may be three or more, instead of two. All the energy storage cells may be connected in series instead of forming the parallel-connected units.

The substrate 201 of the wiring board 200 has openings h2 shown in FIG. 3 at the same positions in an X-Y plane as the openings h1 (FIG. 1). The number of openings h2 is the same as the number of openings h1 (6×N), and each of the openings h2 faces the valve 13 of a corresponding one of the energy storage cells 10 in the Z-direction. The openings h2 are holes that extend through the substrate 201. The openings h2 have a larger dimension in the X-Y plane than the openings h1 (FIG. 1). In the X-Y plane, each opening h1 is located inward of a corresponding opening h2. As shown in FIG. 3, each opening h2 is connected to a corresponding opening h1 via a corresponding lid 105a. The openings h2 are formed by, for example, punching.

In the manufacturing of the energy storage device B, for example, after the wiring board 200 is installed in the lower case 100, the energy storage stacks S1 to S6 are mounted on the wiring board 200 with the surfaces F10 of the energy storage cells facing downward in the vertical direction. The electrode terminals of the energy storage cells 10 and the conductor members of the wiring board 200 may be joined by clinching, thermocompression bonding, welding (e.g., laser welding), or an electrically conductive adhesive. The battery circuit unit 30 is connected to the wiring board 200, and the cooling device 20 is installed in the lower case 100. As a result, the interior of the lower case 100 is in the state shown in FIG. 2. The coolers 22C of the cooling device 20 may be installed in the lower case 100 together with the energy storage stacks S1 to S6. Thereafter, the remaining parts of the cooling device 20 may be placed in the lower case 100, and each of the pipes 22A, 22B may be connected to the coolers 22C. Each of the wiring board 200 and the battery circuit unit 30 may be fixed to the lower case 100 by an adhesive.

As shown in FIG. 3, the upper cover 110 is joined to the upper surfaces (+Z-side surfaces) of the side walls W1 to W4 (only the side wall W3 is shown in FIG. 3) via, for example, an adhesive 110b, and is further fastened by bolts 110a. The common panel 120 is joined to the lower surfaces (−Z-side surfaces) of the side walls W1 to W4 via, for example, an adhesive 120b. Although not shown in FIG. 3, the pipe 22A shown in FIG. 2 is disposed in a space V3 between the side wall W3 and the energy storage cells 10 located at the −Y-side end in the lower case 100.

An exhaust passage P1 is formed between the bottom wall 101 of the lower case 100 and the common panel 120. The side walls W1 to W4 are hollow. As shown in FIG. 3, an exhaust passage P3 is formed inside the side wall W3. Although not shown in the figures, an exhaust passage is also formed inside each of the side walls W2, W4 in a manner similar to that of the exhaust passage P3 of the side wall W3. These exhaust passages communicate with each other. The side wall W2 has exhaust holes connected to the exhaust valves 151, 152 (FIG. 2). These exhaust holes communicate with the exhaust passage.

When the pressure inside the energy storage cell 10 exceeds the first reference value, the valve 13 opens as shown in FIG. 3. As a result, a hole is formed in the lid 105a facing the valve 13 due to the pressure and heat of gas discharged from inside the energy storage cell 10 through the valve 13. The gas discharged from the energy storage cell 10 passes through the hole and flows into the exhaust passage P1. Each of the exhaust valves 151, 152 shown in FIG. 2 opens when the pressure in the exhaust passage exceeds a second reference value. The second reference value may be a pressure value lower than the first reference value. The exhaust valves 151, 152 are, for example, check valves. When either or both of the exhaust valves 151, 152 open, gas in each exhaust passage flows toward the open exhaust valve(s) and is exhausted to the outside of the energy storage device B through that exhaust valve(s). The thickness of each lid 105a provided on the lower case 100 (FIG. 1) is set to a thickness small enough that a hole is formed when the opposing valve 13 opens (for example, when the valve opens in a manner that causes ignition).

A mica layer 120a (e.g., mica foil) is provided on the inner (+Z-side) surface of the common panel 120. The mica layer 120a may be provided so as to overlap all of the lids 105a in the X-Y plane. The mica layer 120a protects the common panel 120 from substances (gas, electrolyte solution, debris, etc.) discharged from the energy storage cells 10 through the lids 105a.

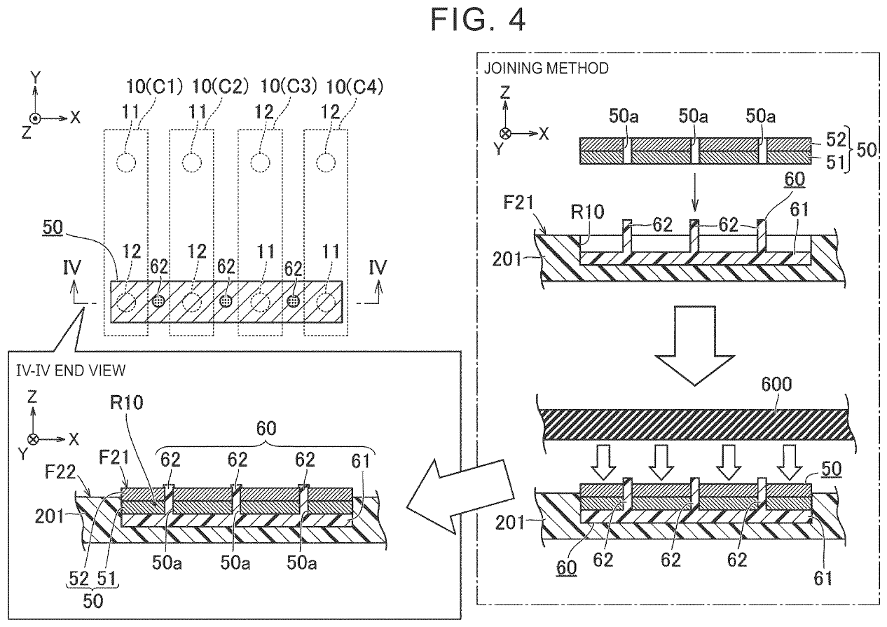

In the present embodiment, each of the conductor members 211 to 216 included in the wiring board 200 has a two-layer structure formed by two conductor members joined by a resin member. Specifically, a conductor member 50 having the structure shown in FIG. 4 is used as each of the conductor members 211 to 216. That is, the wiring board 200 has the wiring pattern (FIG. 2) formed by the conductor members 50. FIG. 4 illustrates the structure of each of the conductor members 211 to 216 in the wiring board 200. A plan view of the conductor member 50 is shown in the upper left part of FIG. 4. An end view of the conductor member 50 taken along line IV-IV in this plan view is shown in the lower left part of FIG. 4. A method for joining two conductor members that form the conductor member 50 is shown on the right side of FIG. 4.

As shown in FIG. 4, the conductor member 50 has a two-layer structure including a conductor member 51 (first conductor member) and a conductor member 52 (second conductor member) that are arranged in the Z-direction. Each of the conductor members 51, 52 is made of a metal (e.g., copper). Each of the conductor members 51, 52 of the conductor member 50 has a rectangular planar shape in the X-Y plane. Each of the conductor members 51, 52 is elongated in the X-direction. The conductor member 51 has the same dimensions in the X-, Y-, and Z-directions as the conductor member 52, and the conductor members 51, 52 are disposed such that their entire areas overlap each other in the Z-direction. However, the present disclosure is not limited to this, and the conductor members 51, 52 may have different thicknesses (dimension in the Z-direction) from each other. The conductor member 50 is connected to four energy storage cells 10 shown by dashed lines in the plan view in FIG. 4. Hereinafter, these four energy storage cells 10 will be referred to as “energy storage cell C1,” “energy storage cell C2,” “energy storage cell C3,” and “energy storage cell C4” from the −X-side.

The conductor member 50 includes: a first mounting portion (first portion) connected to the electrode terminal 12 of the energy storage cell C1 (first energy storage cell); a second mounting portion (second portion) connected to the electrode terminal 12 of the energy storage cell C2 (second energy storage cell); a third mounting portion (third portion) connected to the electrode terminal 11 of the energy storage cell C3 (third energy storage cell); and a fourth mounting portion (fourth portion) connected to the electrode terminal 11 of the energy storage cell C4 (fourth energy storage cell). The energy storage cells C1 to C4 are electrically connected to each other via the conductor member 50 (the joined conductor members 51, 52). Each of the energy storage cells C1 to C4 includes the electrode terminals 11, 12 and the valve 13 (exhaust valve) on the surface F10 facing downward in the vertical direction (see FIG. 3). Although not shown in FIG. 4, the cooler 22C shown in FIG. 2 is disposed between every two energy storage cells that are adjacent in the X-direction (between the energy storage cells C1, C2, between the energy storage cells C2, C3, and between the energy storage cells C3, C4).

In the conductor member 50, the conductor members 51, 52 are joined by a resin sheet 60. The conductor member 50 and the resin sheet 60 are disposed in a recess R10 formed on the +Z-side of the substrate 201. A surface F21 (+Z-side surface) of the conductor member 50 is located on the +Z-side of a surface F22 (+Z-side surface) of the substrate 201. That is, the conductor member 50 protrudes beyond the substrate 201 toward the +Z-side. This facilitates mounting of the electrode terminals of the energy storage cells 10 on the conductor member 50.

The resin sheet 60 includes a plate-shaped body 61 and a plurality of protrusions 62. Each protrusion 62 protrudes from the body 61 toward the +Z-side. The body 61 is in the form of a plate in the X-Y plane, and each of the protrusions 62 extends in the Z-direction. The body 61 and the protrusions 62 may be formed separately and then joined together, or may be integrally formed in a seamless manner.

In the present embodiment, the resin sheet 60 has three protrusions 62 (first to third protrusions). The first protrusion is a protrusion 62 located between the first mounting portion and the second mounting portion of the conductor member 50. The second protrusion is a protrusion 62 located between the second mounting portion and the third mounting portion of the conductor member 50. The third protrusion is a protrusion 62 located between the third mounting portion and the fourth mounting portion of the conductor member 50. The conductor member 50 has three through holes 50a formed at the positions corresponding to the first to third protrusions. The through holes 50a extend through the conductor member 50 in the Z-direction. Each of the first to third protrusions is inserted into a corresponding one of the through holes 50a to fasten the conductor members 51, 52 together. Each of the first to third protrusions serves as a resin rivet having a solid structure. Each of the first to third protrusions fastens the overlapping portion of the conductor members 51, 52. In the present embodiment, each of the protrusions 62 of the resin sheet 60 passes through the conductor members 51, 52 and joins the conductor members 51, 52. The body 61 of the resin sheet 60 is in contact with the −Z-side surface of the conductor member 50 and supports the conductor member 50. The resin sheet 60 with this configuration makes it easier to maintain the connection between the conductor members 51, 52.

When the energy storage device B (see FIGS. 1 and 2) is mounted on a vehicle, vibrations may be applied to the conductor members 211 to 216 due to road surface interference etc. In the present embodiment, the conductor members 50 having the structure shown in FIG. 4 are used as the conductor members 211 to 216 shown in FIG. 2. This reduces connection failures caused by such vibrations. More specifically, in the conductor member 50, the conductor members 51, 52 are joined by the resin member (resin sheet 60). Since the resin member is more prone to elastic deformation than metal, the resin member is more likely to absorb vibrations. Furthermore, since the conductor member 50 has the two-layer structure, the conductor member 50 is also more likely to absorb vibrations. Since the conductor member 50 and the resin sheet 60 absorb vibrations, vibrations are less likely to be transmitted to the connection portion between each energy storage cell 10 and the conductor member 50 (more specifically, the connection portion between the electrode terminal 11 or 12 and the conductor member 50). These vibration-damping and vibration-isolating effects help maintain the connection between each energy storage cell 10 and the conductor member 50. Since the connection between each energy storage cell 10 and the wiring board 200 is maintained, misalignment between the valve 13 and the opening h1 or h2 (see FIG. 3) is also less likely to occur.

In the present embodiment, the entire resin sheet 60 is made of a thermoplastic resin having multiple metal filler particles dispersed therein. The thermoplastic resin may be a nylon resin or a polyamide resin. Thermoplastic resins are more likely to absorb vibrations and are easier to process compared to thermosetting resins. The metal filler particles dispersed in the thermoplastic resin improve the electrical conductivity and mechanical strength of the resin sheet 60. The metal filler particles may include at least one of gold particles, silver particles, copper particles, and nickel particles. The body 61 and the protrusions 62 of the resin sheet 60 may be made of different materials. For example, of the body 61 and the protrusions 62, only the protrusions 62 may contain the metal filler particles. Alternatively, the resin sheet 60 may be made of a resin that does not contain metal filler particles.

The conductor members 51, 52 are joined by, for example, the method shown on the right side of FIG. 4. More specifically, the resin sheet 60 is placed in the recess R10 of the substrate 201. The conductor members 51, 52, each having three through holes at corresponding positions, are stacked to form the conductor member 50 having the three through holes 50a. Thereafter, the conductor member 50 is also placed in the recess R10 of the substrate 201 such that the three protrusions 62 of the resin sheet 60 are inserted into the three through holes 50a of the conductor member 50. The substrate 201 and the resin sheet 60 (body 61) may be joined by any method (e.g., welding, adhesion, or an adhesive). The substrate 201 and the resin sheet 60 may be integrally molded as a single piece.

Subsequently, a hot plate 600 (heated plate) is used to press the three protrusions 62 from the +Z-side, thereby deforming the distal ends of the three protrusions 62. At this time, the distal ends of the protrusions 62 may be crushed while melting the resin with heat. The resultant protrusions 62 are then cooled. As a result, the heads of the resin rivets are formed. The conductor members 51, 52 are thus fastened together by the three protrusions 62.

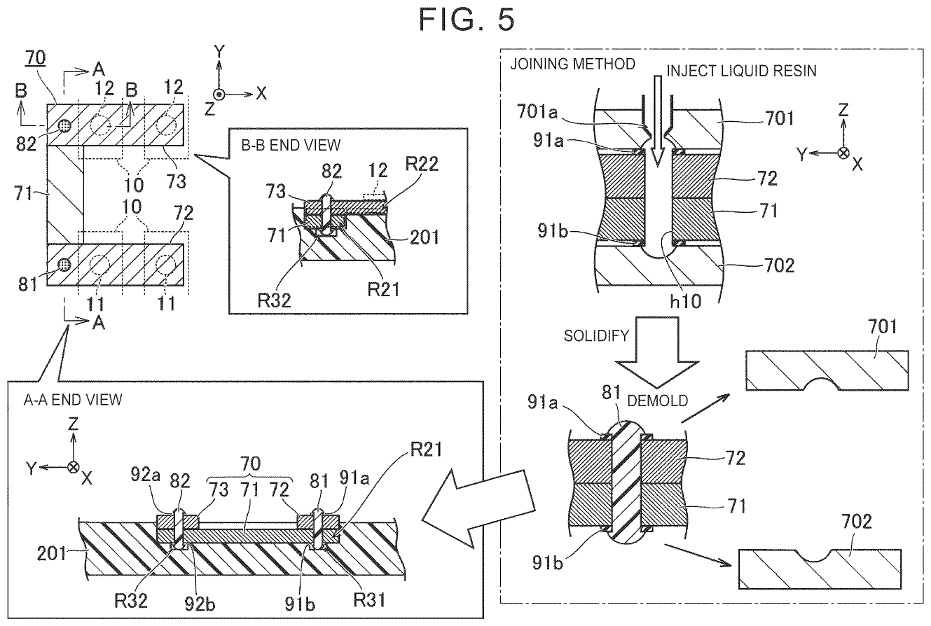

In addition to the conductor members 211 to 216, the conductor members 221 to 223, 231 to 236 may also have a two-layer structure similar to that of the conductor member 50 shown in FIG. 4. However, the structure of each conductor member included in the wiring board 200 is not limited to the structure shown in FIG. 4. For example, the conductor members 221 to 223 may have the structure shown in FIG. 5 instead of the structure shown in FIG. 4.

FIG. 5 illustrates a conductor member according to a first modification. In an energy storage device according to the first modification, a conductor member 70 having the structure shown in FIG. 5 is used as each of the conductor members 221 to 223 shown in FIG. 2. FIG. 5 shows a plan view of the conductor member 70 and end views of the conductor member 70 taken along lines A-A and B-B in the plan view.

As shown in FIG. 5, the conductor member 70 includes a conductor member 71 (first conductor member), a conductor member 72 (second conductor member), and a conductor member 73 (third conductor member). Each of the conductor members 71 to 73 is made of a metal (e.g., copper). The conductor member 70 has a U-shaped planar shape in the X-Y plane. Each of the conductor members 71 to 73 has a rectangular planar shape in the X-Y plane. The conductor member 71 is elongated in the Y-direction. Each of the conductor members 72, 73 is elongated in the X-direction. The conductor member 72 is connected to the electrode terminals 11 of two energy storage cells 10 arranged side by side in the X-direction. The conductor member 73 is connected to the electrode terminals 12 of the two energy storage cells 10 arranged side by side in the X-direction. The conductor members 72, 73 are electrically connected to each other via the conductor member 71.

The conductor members 71, 72 are joined by a resin member 81 (first resin member). More specifically, the conductor members 71, 72 are disposed at a right angle to each other so as to partially overlap each other. The resin member 81 fastens the overlapping portion of the conductor members 71, 72. The conductor members 71, 73 are joined by a resin member 82 (second resin member). The conductor members 71, 73 are disposed at a right angle to each other so as to partially overlap each other. The resin member 82 fastens the overlapping portion of the conductor members 71, 73. Each of the resin members 81, 82 has a head at its both ends in the Z-direction and serves as a resin rivet. A ring-shaped sealing member 91a is provided between the +Z-side head of the resin member 81 and the conductor member 72, and a ring-shaped sealing members 92a is provided between the +Z-side head of the resin member 82 and the conductor member 73. A ring-shaped sealing member 91b is provided between the −Z-side head of the resin member 81 and the conductor member 71, and a ring-shaped sealing members 92b is provided between the −Z-side head of the resin member 82 and the conductor member 71. Each sealing member may be an elastic member. Each sealing member may be an O-ring made of heat-resistant rubber. However, the present disclosure is not limited to this, and each sealing member may be made of a soft metal (e.g., aluminum).

Of the conductor member 70, the conductor member 71 is disposed in a recess R21 formed on the +Z-side of the substrate 201. The overlapping portion of the conductor members 71, 72 and the overlapping portion of the conductor members 71, 73 are also disposed in the recess R21. Recesses R31, R32 for accommodating the −Z-side heads of the resin members 81, 82, respectively, are formed in the bottom surface of the recess R21. The recesses R31, R32 (counterbores) may be used for positioning.

The portion of the conductor member 73 that does not overlap the conductor member 71 is disposed in a recess R22 formed on the +Z-side of the substrate 201. Part of the conductor member 73 protrudes beyond the surface (+Z-side surface) of the substrate 201 toward the +Z-side. The depth dimension of the recess R22 is smaller than the depth dimension of the recess R21. The recess R22 is formed shallower than the recess R21 by an amount corresponding to the thickness of the conductor member 71. Accordingly, the height of the −Z-side surface of the conductor member 73 matches the height of the bottom surface of the recess R22. The conductor member 73 is supported by the substrate 201 within the recess R22.

Although not shown in FIG. 5, a recess for accommodating the portion of the conductor member 72 that does not overlap the conductor member 71 is also formed in the substrate 201 in a manner similar to that of the recess R22. The conductor member 72 is also supported by the substrate 201 within this recess. Part of the conductor member 72 protrudes beyond the surface (+Z-side surface) of the substrate 201 toward the +Z-side.

The conductor member 71 is joined to the conductor members 72, 73 by, for example, the method shown on the right side of FIG. 5. More specifically, the resin members 81, 82 are formed by injection molding. Although FIG. 5 shows only the method for forming the resin member 81, the resin member 82 is also formed in the same manner.

As shown in FIG. 5, a through hole h10 is formed in the overlapping portion of the conductor members 71, 72 at a portion corresponding to the resin member 81. Next, the sealing members 91a, 91b are provided on the +Z-side and −Z-side edge portions of the through hole h10, respectively. A mold is then set on the conductor members 71, 72. Molds 701, 702 are used as the mold. Liquid resin is injected from an injection nozzle 701a in the mold 701. At this time, each of the sealing members 91a, 91b reduces the possibility of the resin flowing out of the mold (molds 701, 702). In the present embodiment, a thermoplastic resin containing a large number of metal filler particles is poured (injected) into the mold. However, the present disclosure is not limited to this, and the liquid resin may be a thermosetting resin (e.g., an epoxy resin). Instead of the sealing members, resin stoppers may be provided on the mold.

Thereafter, the inside of the mold (molds 701, 702) is cooled while maintaining pressure, thereby solidifying the resin. Once the resin (resin member 81) has hardened, the mold is opened (demolding). The resin member 81 is formed in this manner. The resin members 81, 82 may be formed simultaneously. After the demolding, the conductor members 71 to 73 joined by the resin members 81, 82 may be removed and placed in the recess R21 of the substrate 201.

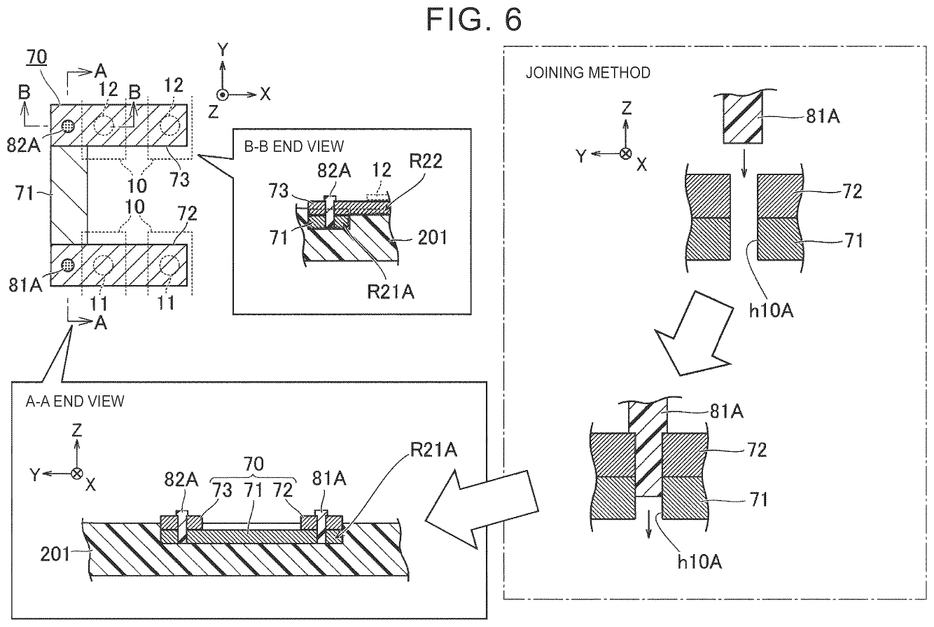

FIG. 6 illustrates a conductor member according to a second modification. An energy storage device according to the second modification has the same configuration as the energy storage device according to the first modification shown in FIG. 5, except that the sealing members 91a, 91b, 92a, 92b are omitted, resin members 81A, 82A are used instead of the resin members 81, 82, and a recess R21A is used instead of the recess R21. Each of the resin members 81A, 82A has a head at its +Z-side end, instead of having a head at its both ends in the Z-axis direction. A recess for accommodating a head of a plastic rivet is not formed in the bottom surface of the recess R21A.

As shown on the right side of FIG. 6, the conductor members 71, 72 may be fastened together by the resin member 81A by press-fitting the resin member 81A into a through hole h10A of the conductor member 70. The through hole h10A is formed at a position corresponding to the resin member 81A. During the press-fitting, the resin member 81A deforms. As a result, the body and head of the resin member 81A (resin rivet) are formed. The conductor members 71, 72 (e.g., busbars) may be energized, and the resin member 81A may be press-fitted into the heated conductor members 71, 72. This facilitates deformation of the resin member 81A (e.g., a thermoplastic resin). With this method, a plurality of conductor members can be easily fastened together by filling through holes of the conductor members with a resin plug. Although FIG. 6 shows only the fastening method using the resin member 81A, the fastening method using the resin member 82A is also the same.

The various features of the energy storage device described above (the features described in the embodiment and the modifications) may be applied in any combination. The energy storage device may be used for any purpose. The energy storage device may be used in vehicles other than automobiles, mobile machines (such as agricultural machines and construction machines), unmanned moving objects, robots, or buildings.

The embodiment disclosed herein should be considered to be illustrative in all respects and not restrictive. The scope of the present disclosure is set forth in the claims rather than in the above description of the embodiment, and is intended to include all modifications within the meaning and scope equivalent to the claims.

What is claimed is:

1. An energy storage device including a first energy storage cell, a second energy storage cell, a first conductor member, and a second conductor member, wherein:
the first energy storage cell and the second energy storage cell are electrically connected to each other via the first conductor member and the second conductor member; and
the energy storage device further includes one or more resin members that join the first conductor member and the second conductor member.

2. The energy storage device according to claim 1, wherein:
each of the first conductor member and the second conductor member has a rectangular planar shape;
the first conductor member and the second conductor member are arranged such that an entire area of the first conductor member and an entire area of the second conductor member overlap each other;
the one or more resin members include a resin member that fastens an overlapping portion of the first conductor member and the second conductor member; and
the first conductor member and the second conductor member that are joined together include a first portion connected to an electrode terminal of the first energy storage cell and a second portion connected to an electrode terminal of the second energy storage cell.

3. The energy storage device according to claim 1, wherein:
the one or more resin members include a resin sheet including a plurality of protrusions; and
each of the protrusions passes through the first conductor member and the second conductor member and joins the first conductor member and the second conductor member.

4. The energy storage device according to claim 1, wherein the one or more resin members are made of a thermoplastic resin in which a plurality of metal filler particles is dispersed.

5. The energy storage device according to claim 1, further comprising:
an upper cover;
a lower case;
a common panel;
a wiring board; and
a cooler, wherein:
the first energy storage cell, the second energy storage cell, and the wiring board are housed between the lower case and the upper cover;
the wiring board includes a wiring pattern provided by a plurality of conductor members including the first conductor member and the second conductor member;
the cooler is disposed between the first energy storage cell and the second energy storage cell;
each of the first energy storage cell and the second energy storage cell includes an electrode terminal and an exhaust valve on a surface that faces downward in a vertical direction; and
an exhaust passage is provided between the lower case and the common panel.
